(19) United States
(12) Patent Application Publication
(10) Pub. No.: US 2011/0198478 A1
(43) Pub. Date: Aug. 18, 2011

(54) Multistage adjustable support assembly

(75) Inventors: Wei-Lin Chang, Taichung City (TW); Sung-Ying Lin, Taichung City (TW)

(73) Assignee: Hiwin Mikrosystem Corp.

(21) Appl. No.: 12/658,987

(22) Filed: Feb. 17, 2010

(51) Int. Cl. F16M 13/00

(52) U.S. Cl. 248/670

(57) ABSTRACT

A multistage adjustable support assembly includes a connecting sleeve axially formed with an axial hole, which is formed with at least one internal threaded portion, an adjustable threaded post received in the axial hole, peripherally formed with at least one first threaded portion for being screwedly coupled with the internal threaded portion, and axially formed with a through hole that is provided therein with at least one second threaded portion, and a support axially extended upward with a rotatable threaded post that is peripherally formed with at least one external threaded portion for being screwedly coupled with and movable along the through hole. The first threaded portion has a thread pitch greater than a thread pitch of the second threaded portion. The multistage adjustable support assembly allows both fine and coarse altitude adjustments an external article it supports with respect to the support.

### BACKGROUND OF THE INVENTION

1. Technical Field

The present invention relates to supports for machines, and more particularly, to a multistage adjustable support assembly for providing a machine with both fine and coarse altitude-adjusting functions.

2. Description of Related Art

An example of a conventional support for large machines is shown in FIG. 1. Therein, a square steel sleeve 2 is provided inside the bottom of a machine and soldered therebelow with a first pad 3, which is formed with an axial hole for allowing a threaded post 5 above a support 4 to pierce therethrough and insert into the square steel sleeve 2. However, the conventional square steel sleeve 2 is made hollow with two laterals so thin. Thus, when the machine is heavy, the burden born by the threaded post 5 is extremely large. For preventing the threaded post 5 from deforming or breaking under such a heavy burden, a removable second pad 6 is typically provided under the first pad 3, wherein the second pad 6 is connected with the first pad 3 by means of bilateral socket head cap screw 7. Thereby, the loading strength of the threaded post 5 is improved. Yet, while the threaded post 5 has a limited length, the presence of the second pad 6 substantially shortens the exposed part of the threaded post 5, and in turn reduces the adjustable length of the threaded post 5. Therefore, the conventional support for large machines only allows fine adjustment. When coarse adjustment of the altitude of a machine is required, it is necessary to first lift the machine up with a forklift and then send workers to remove the second pad 6 under the lifted machine, thereby allowing the threaded post 5 to be screwed to change the distance between the second pad 6 and the support 4 so as to finish the coarse adjustment before reassembling the second pad 6 under the first pad 3.

However, the foregoing way for accomplishing coarse altitude adjustment which involves the operation of a forklift and complicated operation conducted by several workers under the machine is not only time-consuming but also dangerous to the workers.

On the other hand, the threaded post 5 usually has the threads formed equidistantly. While the thread pitch made relatively large brings up the problem about imprecision and errors of combination between the threaded post 5 and the axial hole, leading to imprecise leveling of the machine, the thread pitch made relatively small that satisfies the requirement of precision is inefficient in coarse adjustment. Thus, the conventional support with such a threaded post 5 is a compromise either way. In short, the threaded post 5 of the conventional support fails to simultaneously achieve quickness and precision of its adjustment in the axial hole due to its constant thread pitch. Hence, there is a need for a support that is suitable for both coarse and fine altitude adjustments of machines.

### SUMMARY OF THE INVENTION

To summarize the problems of the prior art, the conventional support for heavy machines is designed for direct fine altitude adjustment of machines only. In coarse altitude adjustment, the conventional support requires time-consuming and dangerous operations, and its threaded post with constant thread pitch fails to achieve convenient coarse and fine altitude adjustments. In view of the above-recited shortcomings of the prior art, the present invention provides a multistage adjustable support assembly.

The multistage adjustable support assembly includes a connecting sleeve axially formed with an axial hole, which is formed with at least one internal threaded portion, an adjustable threaded post received in the axial hole, peripherally formed with at least one first threaded portion for being screwedly coupled with the internal threaded portion, and axially formed with a through hole that is provided therein with at least one second threaded portion, and a support axially extended upward with a rotatable threaded post that is peripherally formed with at least one external threaded portion for being screwedly coupled with and movable along the through hole. The first threaded portion has a thread pitch greater than a thread pitch of the second threaded portion. The multistage adjustable support assembly allows both fine and coarse altitude adjustments of an external article it supports with respect to the support.

One objective of the present invention is to make use of the different thread directions and thread pitches of the first threaded portion and the second threaded portion of the adjustable threaded post to quickly achieve coarse adjustment and fine adjustment of the altitude of the external article with respect to the support.

Another objective of the present invention is to move the external article upward or downward by directly using the adjustable threaded post, so as to eliminate the complex, time-consuming and dangerous operations required by the prior art where a forklift has to lift the external article to allow worker to assemble or disassemble pads below the lifted external article.

Another objective of the present invention is to position the adjustable threaded post and rotatable threaded post by the presence of the first adjusting nut and the second adjusting nut, so as to improve the strength of the multistage adjustable support assembly.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 illustrates a conventional support for heavy machines;

FIG. 2 is an exploded view of a multistage adjustable support assembly according to the present invention;

FIG. 3 is a perspective view of the multistage adjustable support assembly of the present invention;

FIGS. 4 and 5 illustrate how the multistage adjustable support assembly performs coarse altitude adjustment; and

FIG. 6 illustrates how the multistage adjustable support assembly performs fine altitude adjustment.

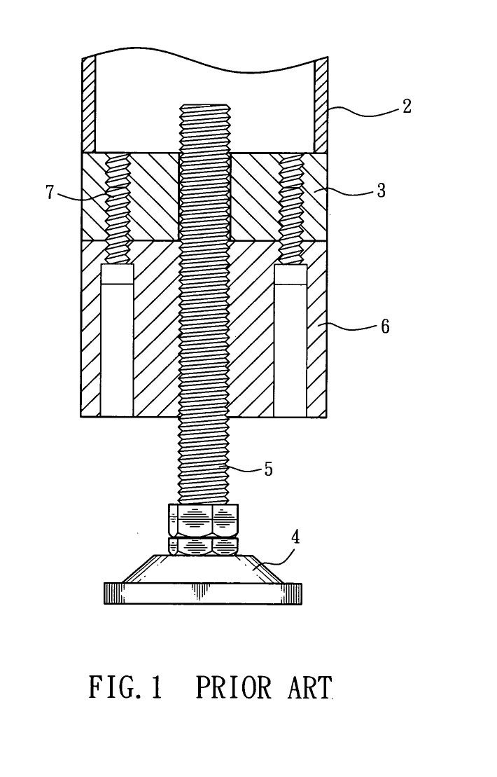

### DETAILED DESCRIPTION OF THE PREFERRED EMBODIMENT

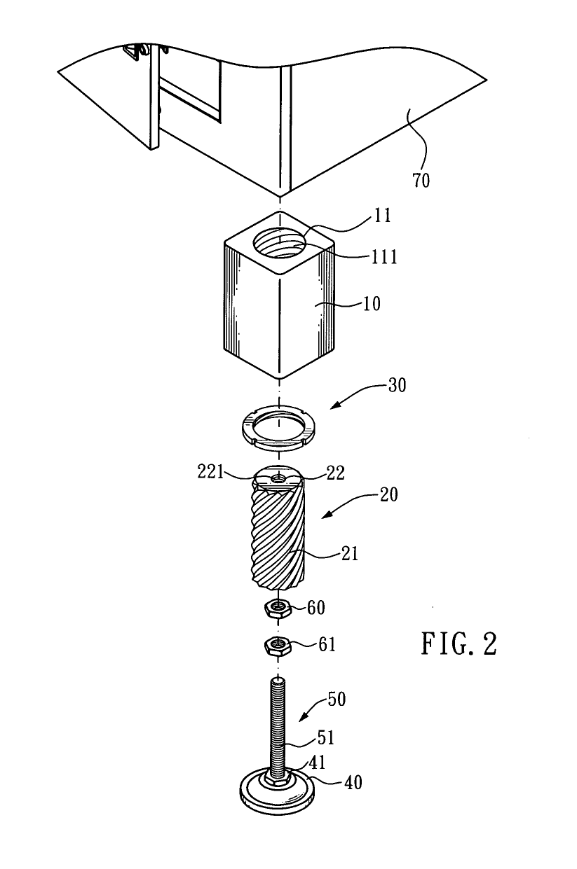

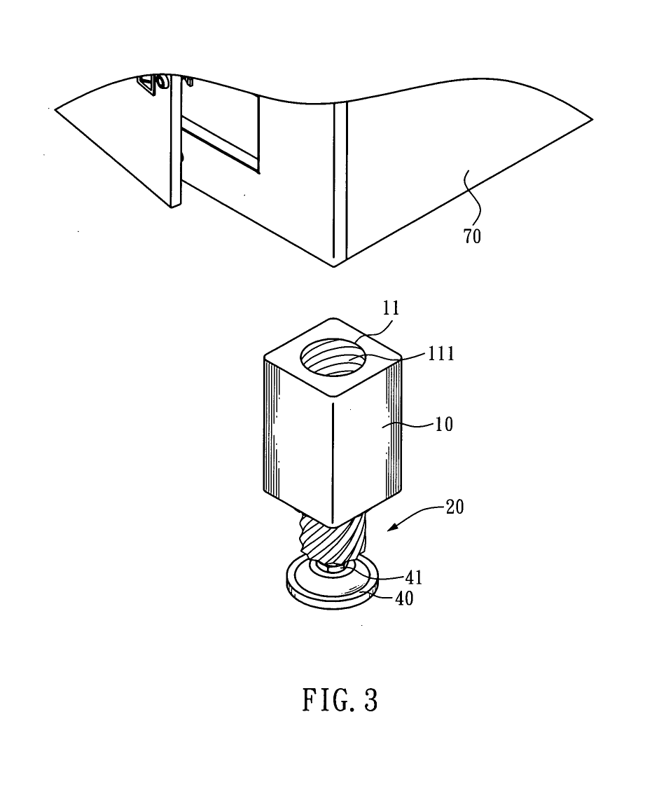

Referring to FIG. 2 and FIG. 3, the present invention proposes a multistage adjustable support assembly, which mainly includes a connecting sleeve 10, an adjustable threaded post 20, a first adjusting nut 30, a support 40, a rotatable threaded post 50, and a second adjusting nut 60. The connecting sleeve 10 has a rectangular shape and is soldered with a square steel sleeve (not shown) fixed inside a bottom of an external article 70, which is, for example, a machine to be supported. The connecting sleeve 10 is axially formed with an axial hole 11, which is internally formed with at least one internal threaded portion 111 composed of left-hand threads.

The adjustable threaded post 20 is received in the axial hole 11 and peripherally formed with at least one first threaded portion 21. The first threaded portion 21 is composed of left-hand threads corresponding to and configured to be screwedly coupled with those of the internal threaded portion 111. The adjustable threaded post 20 is axially formed with a through hole 22, which has there in at least one second threaded portion 221 with right-hand threads. The first threaded portion 21 has a thread pitch greater than that of the second threaded portion 221.

The first adjusting nut 30 is screwedly coupled with and movable along the adjustable threaded post 20 by rotating with respect to the first threaded portion 21 in order to position the adjustable threaded post 20.

The support 40 is axially extended upward with a rotatable threaded post 50, which is peripherally formed with at least one external threaded portion 51. The rotatable threaded post 50 is screwedly coupled with and movable along the through hole 22 by rotation. Therein, the external threaded portion 51 is composed of right-hand threads. The support 40 is mounted with at least one fastening nut 41 that is screwedly coupled with the rotatable threaded post 50 so that the rotatable threaded post 50 has its lower end firmly coupled with the support 40 in order to ensure that when the rotatable threaded post 50 rotates inside the through hole 22, the support 40 is secured from coming off.

The second adjusting nut 60 is screwedly coupled with and movable along the rotatable threaded post 50 by rotating on the external threaded portion 51 for positioning the rotatable threaded post 50. A reinforcing nut 61 provided under the second adjusting nut 60 is screwedly coupled with the rotatable threaded post 50 for reinforcing the second adjusting nut 60.

Basing on the above structure, the operational principle of the disclosed assembly will be illustrated below.

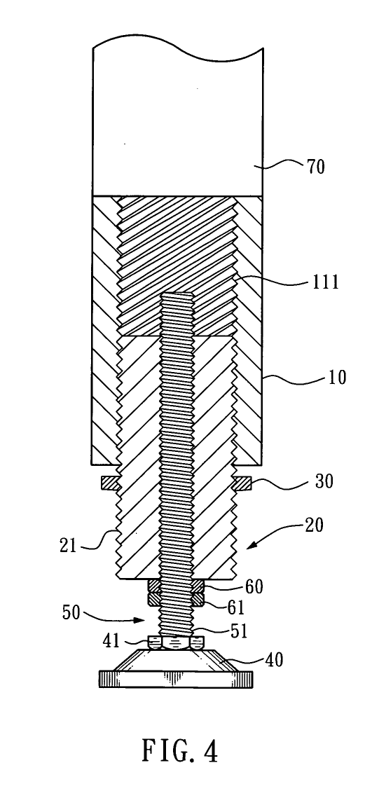

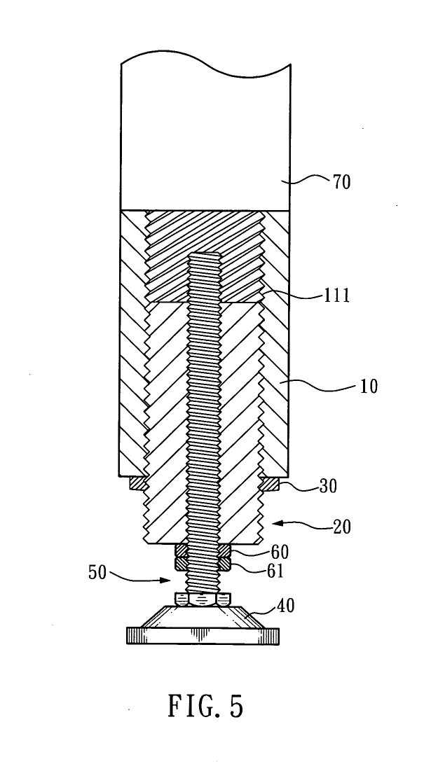

As shown in FIG. 4 and FIG. 5, when it is desired to coarsely adjust the altitude of the bottom of the external article 70 with respect to the support 40, the first adjusting nut 30 is first unscrewed by a wrench and then moved downward through rotation. Afterward, a wrench is used to hold the fastening nut 41 still, while another wrench is used to rotate the second adjusting nut 60, so as to drive the adjustable threaded post 20 to move upward or downward for quickly moving the adjustment external article 70 to the desired altitude. The first threaded portion 21 is screwedly coupled with the internal threaded portion 111. At this time, the first adjusting nut 30 is further moved upward to abut against a lower end of the connecting sleeve 10, so that the adjustable threaded post 20 is positioned with respect to the axial hole 11.

Since the first threaded portion 21 and the second threaded portion 221 of the adjustable threaded post 20 are composed of the left-hand threads and the right-hand threads, respectively, and have different thread pitches, it is possible to coarsely and finely adjusting the altitude of the bottom of the external article 70 with respect to the support 40.

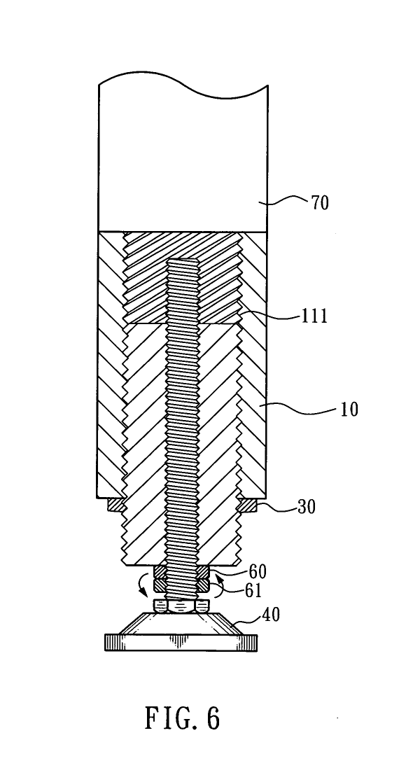

Referring to FIG. 6, when it is desired to finely adjust the altitude of the bottom of the external article 70 with respect to the support 40, different from the operation for coarse adjustment as described above, it is no need to unscrew the first adjusting nut 30. In stead, the operation of fine adjustment involves only holding the fastening nut 41 still with one wrench while rotating the second adjusting nut 60 with another wrench, so as to move the rotatable threaded post 50 upward or downward between the reinforcing nut 61 and the fastening nut 41, thereby accomplishing fine altitude adjustment. The external threaded portion 51 is screwedly coupled with the second threaded portion 221. At this time, the second adjusting nut 60 is screwed to abut against the lower end of the adjustable threaded post 20, so as to position the rotatable threaded post 50 with respect to the through hole 22.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A multistage adjustable support assembly comprising:
a connecting sleeve axially provided with an axial hole, which is formed therein with at least one internal threaded portion;
an adjustable threaded post received in the axial hole, peripherally formed with at least one first threaded portion for being screwedly coupled with the internal threaded portion, and axially formed with a through hole that is provided therein with at least one second threaded portion; and
a support axially extended upward with a rotatable threaded post that is peripherally formed with at least one external threaded portion for being screwedly coupled with and movable along the through hole,
wherein the first threaded portion has a thread pitch greater than a thread pitch of the second threaded portion, thereby, when the connecting sleeve being fixed to an external article to be supported, the multistage adjustable support assembly allowing both fine altitude adjustment and coarse altitude adjustment of the external article with respect to the support.

2. The multistage adjustable support assembly of claim 1, further comprising a first adjusting nut screwedly coupled with the first threaded portion and movable along the adjustable threaded post for positioning the adjustable threaded post.

3. The multistage adjustable support assembly of claim 1, further comprising a second adjusting nut screwedly coupled with the external threaded portion and movable along the rotatable threaded post for positioning the rotatable threaded post.

4. The multistage adjustable support assembly of claim 3, wherein a reinforcing nut is provided under the second adjusting nut.

5. The multistage adjustable support assembly of claim 1, wherein the first threaded portion is composed of left-hand threads.

6. The multistage adjustable support assembly of claim 5, wherein the internal threaded portion is composed of left-hand threads corresponding to the first threaded portion.

7. The multistage adjustable support assembly of claim 1, wherein the second threaded portion is composed of right-hand threads.

8. The multistage adjustable support assembly of claim 7, wherein, the external threaded portion is composed of right-hand threads corresponding to the second threaded portion.

9. The multistage adjustable support assembly of claim 1, wherein a fastening nut provided above the support is screwedly coupled with the rotatable threaded post.

10. The multistage adjustable support assembly of claim 1, wherein the connecting sleeve is in a rectangular shape.
